(19) United States
(12) Patent Application Publication
(10) Pub. No.: US 2026/0008518 A1
(43) Pub. Date: Jan. 8, 2026

(54) EXCHANGEABLE DRIVE ASSEMBLY FOR COUPLING WITH HUB SHELL FOR A BICYCLE WHEEL

(71) Applicant: Classified Cycling BV, Antwerpen (BE)

(72) Inventor: Roëll Marie VAN DRUTEN, Eindhoven (NL)

(21) Appl. No.: 19/259,935

(22) Filed: Jul. 3, 2025

(30) Foreign Application Priority Data
Jul. 3, 2024 (NL) 2038137

(51) Int. Cl. B62M 11/16; B60B 27/02; B60B 27/04

(52) U.S. Cl. CPC B62M 11/16; B60B 27/023; B60B 27/047

(57) ABSTRACT

The disclosure relates to a hub assembly for a driven wheel of a bicycle, comprising a hub shell for connection to a rim of the driven wheel, and an exchangeable drive assembly for being exchangeably couplable to the hub shell. The exchangeable drive assembly comprises an axle; a substantially cylindrical driver body rotatable about the axle and configured for carrying a cassette of sprockets; and an inner hub body rotatable axially adjacent the driver body about the axle and comprising a splined first coupling interface configured for providing a direct-drive coupling between the inner hub body and the hub shell and a second coupling interface configured for providing a direct-drive coupling between the inner hub body and the driver body.

### CLAIM FOR PRIORITY

This application claims the benefit of priority of Dutch Application No. 2038137, filed Jul. 3, 2024, which is hereby incorporated by reference in its entirety.

### FIELD

The disclosure relates to a hub assembly for a driven wheel of a bicycle.

### BACKGROUND

Hub assemblies for a driven bicycle wheel typically include a hub shell for connection to a rim of the bicycle wheel, and a driver body receiving a cassette of one or more sprockets. Most known hub assemblies include a direct-drive coupling between the driver body and the hub shell, often via a freewheel mechanism. A rider of the bicycle can input power through a chain or belt drive to a sprocket of the cassette to drive driver body and hence the hub shell in rotation about a wheel axis of the bicycle wheel.

In conventional hub assemblies, a range of selectable gear ratios is provided by the cassette including multiple sprockets carried by a cylindrical driver, wherein a derailleur is provide to enable the rider to shift the chain or belt between any of the sprockets to change the gear ratio.

Some other known hub assemblies include an internal hub transmission housed by the hub shell, and operative between the driver body and the hub shell. The internal hub transmission is switchable between multiple gear ratios.

WO2017/039442 describes an exemplary hub assembly comprising a driver body for carrying multiple sprockets, as well as an internal hub transmission operative between the driver body and the hub shell. The driver body of this system is conically shaped for housing a substantial part of internal hub transmission that is operative between the driver body and the hub shell. The conical driver body can carry an accordingly shaped cassette of sprockets.

WO2023/247786 also describes a hub assembly with an internal hub transmission, here generally housed by the hub shell, wherein a conventional cylindrical driver body is provided for carrying a conventional cassette of sprockets.

The use of an internal hub transmission in combination with cassette of sprockets may not be essential for each and every situation. It may therefore be desirable to be able to remove the internal hub transmission from the hub assembly to save weight, and still be able to use the hub shell with the rim connected thereto.

### SUMMARY

It is an object to propose a hub assembly for bicycle wheel.

An aspect provides a hub assembly for a driven wheel of a bicycle, comprising a hub shell for connection to a rim of the driven wheel, and an exchangeable drive assembly for being exchangeably couplable to the hub shell. The exchangeable drive assembly comprises an axle; a substantially cylindrical and/or conical driver body rotatable about the axle and configured for carrying a cassette of sprockets; and an inner hub body rotatable axially adjacent the driver body about the axle and comprising a splined first coupling interface configured for providing a direct-drive coupling between the inner hub body and the hub shell and a second coupling interface configured for providing a direct-drive coupling between the inner hub body and the driver body. The exchangeable drive mechanism may also be referred to herein as an exchangeable first drive mechanism.

The driver body can e.g. be substantially cylindrical. This can e.g. be useful for carrying e.g. 10-15 speed cassettes. The driver body can e.g. be substantially cylindrical, such as with a diameter increasing towards an axial center of the axle.

The drive assembly hence provides a fixed unitary transmission ratio between the driver body and the inner hub body. The hub assembly particularly allows a hub shell suitable for receiving an internal hub transmission to be used without the internal hub transmission. The drive assembly can hence replace the internal hub transmission, to provide a direct-drive functionality between the driver body and the hub shell. The hub shell may hence be configured for holding an internal hub transmission. The hub shell may particularly be configured for also, instead of the drive assembly, holding a further drive assembly comprising an axle; a substantially conical driver body rotatably about the axle and configured for carrying a cassette of sprockets; an inner hub body rotatable axially adjacent the driver body about the axle and comprising the splined first coupling interface configured for providing the direct-drive coupling between the inner hub body and the hub shell; and a switchable transmission operative between the driver body and the inner hub body.

It will be appreciated that a direct-drive coupling between two elements as described herein provides a direct speed, force or torque transfer from one of said element to the other element of said elements in a one-to-one relation without involving any intermediate gearing.

Another aspect provides an exchangeable drive assembly for being exchangeably couplable to a hub shell of a driven wheel of a bicycle. The drive assembly comprises an axle; a substantially cylindrical driver body rotatable about the axle and configured for carrying a cassette of sprockets; and an inner hub body axially adjacent the driver body, the inner hub body being rotatable about the axle and comprising a splined first coupling interface configured for providing a direct-drive coupling between the inner hub body and the hub shell and a second coupling interface configured for providing a direct-drive coupling between the inner hub body and the driver body.

Another aspect provides a kit, comprising a hub shell for being selectively coupled to any one exchangeable drive assembly selected from a group of exchangeable drive assemblies that includes an exchangeable first drive assembly and an exchangeable second drive, the exchangeable first drive assembly and the exchangeable second drive assembly. The exchangeable first drive assembly comprises a first axle; a substantially cylindrical driver body rotatable about the axle and configured for carrying a cassette of sprockets of a first type; and a first inner hub body rotatable axially adjacent the driver body about the first axle and comprising a splined first coupling interface configured for providing a direct-drive coupling between the inner hub body and the hub shell, and a second coupling interface configured for providing a direct-drive coupling between the inner hub body and the driver body. The second drive assembly comprises a second axle; a substantially conical driver body rotatably about the axle and configured for carrying a cassette of sprockets of a second type; an second inner hub body rotatable axially adjacent the driver body about the axle and comprising the splined first coupling interface configured for providing the direct-drive coupling between the inner hub body and the hub shell; and a switchable transmission operative between the driver body and the inner hub body. It will be appreciated that the first axle and the second axle may the same axle, or that first axle and the second axle may be respective axles that are either identically to or differently configured from each other.

Another aspect provides a hub assembly for a driven wheel of a bicycle, comprising a hub shell for connection to a rim of the driven wheel, and an exchangeable drive assembly for being exchangeably couplable to the hub shell. This exchangeable drive mechanism may be referred to as an exchangeable third drive mechanism. The exchangeable drive assembly comprises: an axle; a substantially conical driver body rotatable about the axle and configured for carrying a cassette of sprockets; an inner hub body rotatable axially adjacent the driver body about the axle and comprising a splined first coupling interface configured for providing a direct-drive coupling between the inner hub body and the hub shell and a second coupling interface configured for providing a direct-drive coupling between the inner hub body and the driver body.

Another aspect provides a method of assembling a hub assembly for a driven wheel of a bicycle. The method comprises providing a hub shell configured for being selectively coupled to any one exchangeable drive assembly selected from a group of exchangeable drive assemblies that includes an exchangeable first drive assembly and an exchangeable second drive assembly and optionally an exchangeable third drive assembly; selecting an exchangeable drive assembly from the set of exchangeable drive assemblies; and coupling the splined first interface of the selected exchangeable drive assembly to obtain a coupling between the inner hub body and the hub shell in the direct-drive relation. The exchangeable first drive assembly comprises a first axle; a substantially cylindrical driver body rotatable about the axle and configured for carrying a cassette of sprockets of a first type; a first inner hub body rotatable axially adjacent the driver body about the first axle and comprising a splined first coupling interface configured for providing a direct-drive coupling between the inner hub body and the hub shell, and a second coupling interface configured for providing a direct-drive coupling between the inner hub body and the driver body. The second drive assembly comprises a second axle; a substantially conical driver body rotatably about the axle and configured for carrying a cassette of sprockets of a second type; an second inner hub body rotatable axially adjacent the driver body about the axle and comprising the splined first coupling interface configured for providing the direct-drive coupling between the inner hub body and the hub shell; a switchable transmission operative between the driver body and the inner hub body.

The following options and features may apply to any of the aspects. It will be appreciated that the following features and options can be combined.

Optionally, the hub assembly comprises a freewheel mechanism operative between the driver body and the second coupling interface of the inner hub body for transferring torque from the driver body to the inner hub in one rotational direction about the axle and allow freewheeling of the driver body relative to the inner hub body in an opposite rotational direction about the axle.

Optionally, the exchangeable drive assembly is a direct-drive assembly configured for providing a fixed transmission path between the driver body and the hub shell. The fixed transmission path can have a unitary transmission ratio.

Optionally, the exchangeable drive assembly comprises a planetary reduction ratio between the driver body and the hub shell.

Optionally, the driver body is bearing mounted to the axle, preferably by at least two bearings.

Optionally, the inner hub body is bearing mounted to the axle, preferably by at least two bearings.

Optionally, the hub shell comprises a first flange and a second flange for attachment of spokes. The first flange can be on the drive side, the second flange can be on the non-drive side. The first flange can have a larger diameter that the second flange.

Optionally, the freewheel mechanism comprises ratchet teeth protruding in axial direction with respect to the axle.

Optionally, the freewheel mechanism comprises ratchet teeth protruding in radial direction with respect to the axle.

Optionally, the freewheel mechanism comprises ratcheting pawls mounted to the driver body.

Optionally, the freewheel mechanism comprises ratcheting pawls positioned on a larger diameter than the first coupling interface.

Optionally, the freewheel mechanism is embodied as a one-way bearing.

Optionally, the freewheel mechanism comprises ratchet teeth protruding in both an axial direction and a radial direction with respect to the axle.

Optionally, the hub assembly comprises a sealing interface configured for providing a sealing engagement between the driver body and the inner hub body.

Optionally, the inner hub body at the splined first interface includes axial splines arranged for enabling exchange of the drive assembly in axial direction with respect to the axle.

Optionally, the drive body includes axial splines for supporting torque from the cassette of sprockets about the axle, and wherein the axial splines of the driver body and the axial splines of the inner hub body protrude in radial direction to a substantially corresponding radius.

Optionally, the inner hub body at the splined first interface includes an axial abutment face for abutting a complementary abutment face associated with the hub shell.

Optionally, the hub assembly comprises a lock ring arranged for locking the inner hub body to the hub shell in axial direction with respect to the axle.

Optionally, the hub assembly comprises an inner hub body and the lock ring include complementary inner and outer threads respectively, and wherein the lock ring is configured to the hub shell while threading with inner thread of the inner hub body.

Optionally, the inner hub body is substantially cylindrical.

Optionally, the hub assembly comprises an annular shielding element that radially extends between the inner hub body and the hub shell in for shielding a gap between the inner hub body and the hub shell.

Optionally, the shielding element is sealingly engaged between the inner hub body and the hub shell.

Optionally, the sealing element is constructed of a resilient material and arranged for being snappingly engaged between the inner hub body and the hub shell.

Optionally, the axle is monolithic. The axle may hence be constructed as a singular piece.

Optionally, the axle extends in axial direction from a non-drive side end at a non-drive side of the hub assembly to an opposite drive side end beyond driver body.

Optionally, the inner hub body directly radially supports the hub shell.

Optionally, the substantially conical driver body includes a coupling profile for coupling the cassette of sprockets thereto, wherein the coupling profile includes

Optionally, the substantially conical driver includes a coupling profile for coupling the cassette of sprockets thereto, wherein the coupling profile includes a first support structure at a first radius from a centerline of the axle, configured for supporting the set of sprockets in a radial direction and/or an axial direction and/or tangential direction, and a second support structure at a second radius from the centerline larger than the first radius, configured for supporting the set of sprockets in a tangential direction.

Optionally, the substantially conical driver body includes a third coupling structure at a third radius from the centerline larger than the first radius and smaller than the second radius, configured for supporting the set of sprockets in a radial direction and/or an axial direction and/or tangential direction.

Optionally, the first and/or the third coupling structure is configured for supporting the set of sprockets in the axial direction, e.g. wherein only the second interface is configured for supporting the cassette in the axial direction.

It will be appreciated that any of the aspects, features and options described herein can be combined. It will particularly be appreciated that any of the aspects, features and options described in view of the hub assembly, the drive assembly and the kit apply equally to the method, and vice versa.

### BRIEF DESCRIPTION OF THE DRAWINGS

Embodiments of the present invention will now be described in detail with reference to the accompanying drawings in which:

FIGS. 1 and 2 show cross-sectional views of respective exemplary hub assemblies;

FIGS. 3A and 3B show perspective views of a hub assembly and a drive assembly respectively; and

FIG. 4 shows an example of a hub assembly similar to the example of FIG. 1.

### DETAILED DESCRIPTION

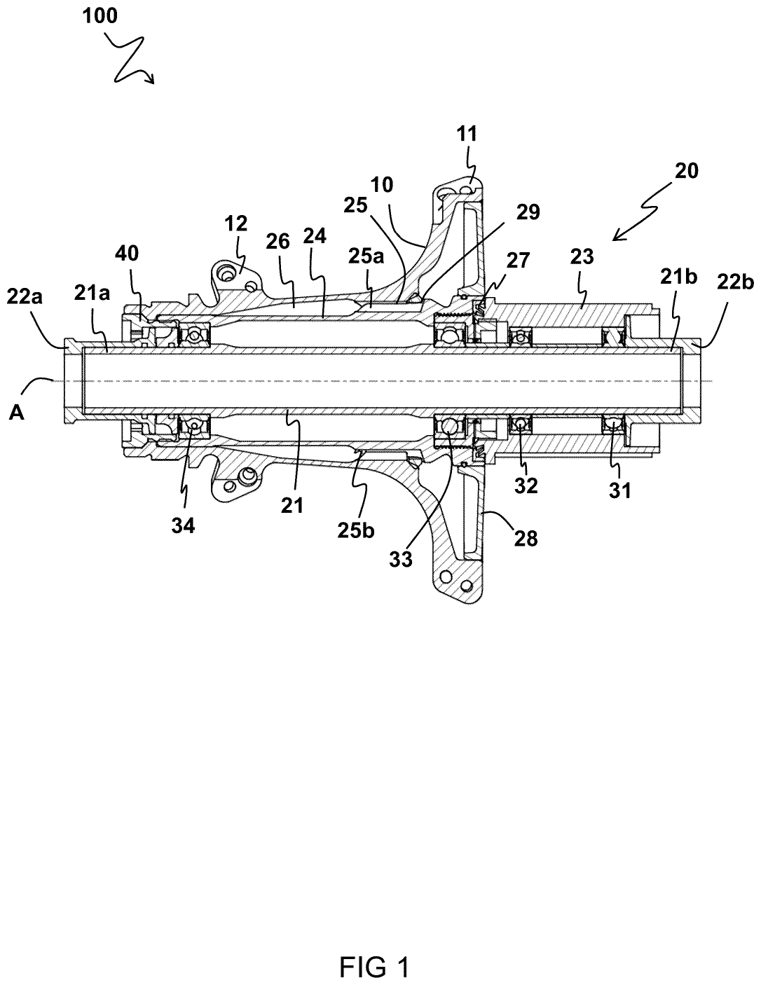

FIG. 1 shows an example of a hub assembly, referred to herein as a first hub assembly 100, for a driven bicycle wheel. The first hub assembly 100 comprises a hub shell 10. The hub shell 10 is provided with spoke flanges 11 and 12 for coupling to spokes, which in turn couple to a rim of the bicycle wheel.

The first hub assembly 100 also comprises an exchangeable drive assembly 20, referred to herein as an exchangeable first drive assembly 20. The exchangeable first drive assembly comprises an axle 21. The axle 21 extends along a rotation axis A of the bicycle wheel. The axle 21 extends between two opposing ends 21a, 21b. Axle end caps 22a, 22b are provided at each axle end 21a, 21b. The axle 21 is non-rotatably couplable to a frame of the bicycle, particularly between opposing dropouts of a frame fork. Here the axle 21 is hollow, for receiving a thru-axle to therethorough for coupling the axle 21 to the bicycle frame.

The first drive assembly 20 also comprises a substantially cylindrical driver body 23 rotatable about the axle 21 and configured for carrying a cassette of sprockets. The driver body 23 is in this example a conventional cylindrical driver body as known in the art.

The first drive assembly 20 also comprises an inner hub body 24. The inner hub body 24 is rotatable about the axle 21. The inner hub body 24 is arranged axially adjacent the driver body 23. The inner hub body 24 comprises a splined first coupling interface 25 configured for providing a direct-drive coupling between the inner hub body 24 and the hub shell 10. The inner hub body 24 is here provided with axial splines 25a that protrude in radial direction and extend in axial direction, parallel to the rotation axis A. The axial splines 25a mesh with complementary axial splines 25b of the hub shell 10 for providing a fixed direct-drive coupling between the inner hub body 24 and the hub shell 10. Torque is accordingly transferred from the inner hub body 24 to the hub shell 10 and vice versa in a direct one-to-one relation. The splined first coupling interface 25 allows the inner hub body 24 to be axially received in, and removed from, a hub cavity 26 defined by the hub shell 10.

The drive first assembly 20 also includes a second coupling interface 27 configured for providing a direct-drive coupling between the inner hub body 24 and the driver body 23. The first drive assembly 20 in this example comprises a freewheel mechanism 27, or a one-way bearing, operative between the driver body 23 and the inner hub body 24. Hence, here, torque can be transferred in one-to-one relation from the driver body 23 to the inner hub body 24 in one relative rotation direction about the axis A, while the driver body 23 is enabled to rotate relative to the inner hub body 24 in the opposite relative rotation direction. The freewheel mechanism is in this example a conventional free-wheel mechanism known in the art, particularly here including axial ratchet teeth and axially biased pawls.

The first hub assembly 100 in this example accordingly provides a direct-drive from the driver body 23 via the inner hub body 24 to the hub shell 10. There is hence no selectable transmission ratio provided between the driver body 23 and the hub shell 10.

The driver body 23 is in this example bearing mounted to the axle 21, here by two roller bearings 31, 32. Also, here, the inner hub body 24 is bearing mounted to the axle 21, here by two bearings 33, 34.

The first hub assembly 100 also includes in this example a lock ring 40. The lock ring 40 threads into a non-drive side end of the inner hub body 24, and thereby engages the hub shell 10. The lock ring 40 hence locks the hub shell 10 relative to the inner hub body 24 in axial direction, here in cooperation with the splined first interface 25, which is provided with an axial abutment face 29.

The first hub assembly 100 in this example also comprises a shielding element 28, that covers cap between the hub shell 10 and the inner hub member 24. The shielding element 28 is annularly shaped, and sealingly engages the inner hub member 24 at an inner radius and sealingly engages the hub shell 10 at an outer radius. The shielding element 28 may be omitted.

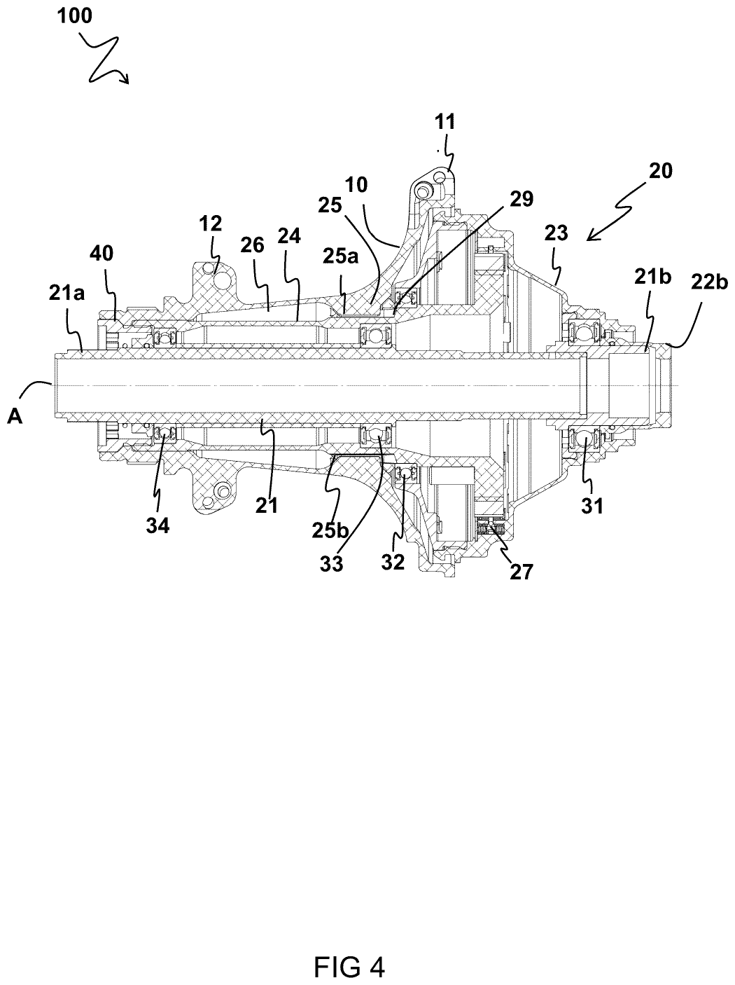

FIG. 4 shows an example of a hub assembly 100 similar to the example of FIG. 1. In the example of FIG. 4, the driver body 23 is substantially conical instead of substantially cylindrical. The substantially conical driver body 23 has a diameter that increases towards an axial center of the hub assembly 100. In this example, the freewheel mechanism 27 is embodied as a one-way bearing. For the understanding of the hub assembly 100 of FIG. 4 is referred to the above description in view of FIG. 1, mutatis mutandis.

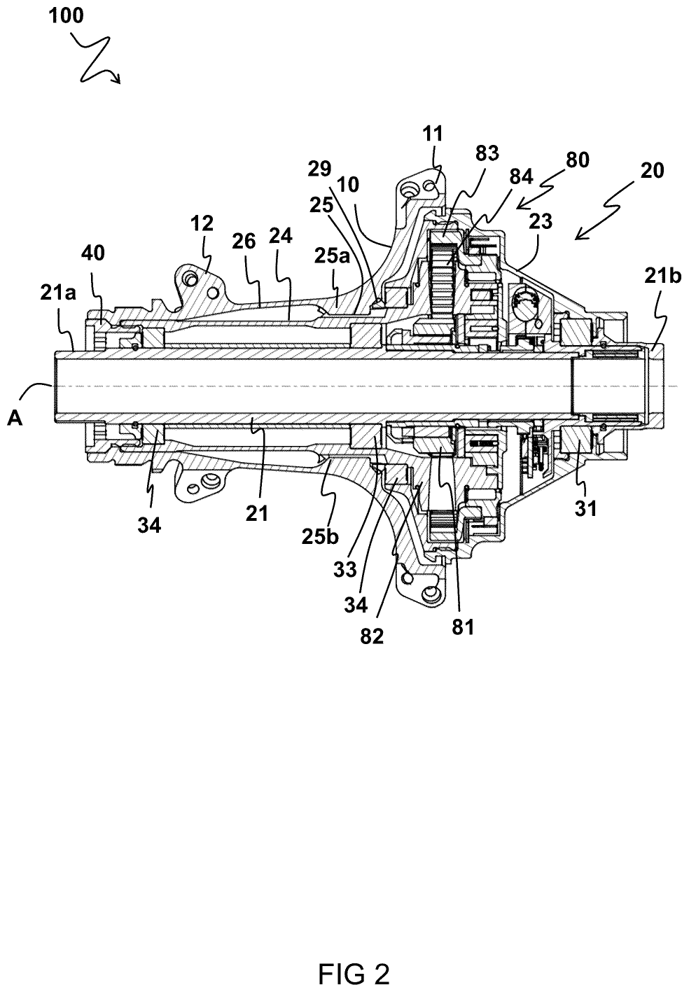

FIG. 2 shows another example of a hub assembly 200, referred to herein as a second hub assembly. The second hub assembly 200 comprises a hub shell 10 being the same as the hub shell 10 of the first hub assembly 10-of the example of FIG. 1. The second hub assembly 200 of FIG. 2 however includes a different drive assembly 20, referred to herein as a second drive assembly. In this example, the second drive assembly 20 includes a substantially conical driver body 23 rotatably about an axle 20 and configured for carrying a cassette of sprockets. The cassette of sprockets in this example may of a different type compared to the first hub assembly, due to differently shaped driver body 20. The conical driver body 23 and the associated cassette of sprockets may for example be as disclosed in WO2017/039442, the entire content of which is incorporated herein by reference.

Like for the exchangeable first drive assembly 20 of the first hub assembly 100, the exchangeable second drive assembly 20 of the second hub assembly 200 includes an inner hub body 24. The inner hub body 24 of the second hub assembly 200 is differently shaped from the inner hub body 24 of the first hub assembly 100. The inner hub body 24 is rotatable adjacent the driver body 23 about the axle 20, and comprises the splined first coupling interface 25 configured for providing the direct-drive coupling between the inner hub body 24 and the hub shell 10.

The second drive assembly 20 of the second hub assembly 200 comprises a switchable transmission 80 operative between the driver body 23 and the inner hub body 24. Here, the switchable transmission 80 includes a planetary gear set, in this example including a sun gear 81, planet gears 84 carried by a carrier 82 and a ring gear 83. The carrier 81 is in this example an input to the transmission 80 and is connected to driver body 23, and the ring gear 83 is an output of the transmission 80 and is connected to the inner hub body 24. The transmission 80 is housed by the hub shell 10 and the driver body 23, and is configured to selectively provide a non-unitary, e.g. a speed-increasing or speed-decreasing transmission ratio between the driver body 23 and the inner hub body 24. The inner hub body 24 is in turn via the splined first interface 25 coupled to the hub shell 10, to provide a unitary, direct-drive, transfer of speed and torque between the inner hub body 24 and the hub shell 10.

Here, the inner hub body 24 is bearing mounted to the axle 21, here by two roller bearings 33, 34. Further, here, the driver body 23 is bearing mounted to the axle 21 by only one bearing 31. The driver body 23 is further bearing mounted to the inner hub body 24 by another bearing 32.

The disclosure also relates to another hub assembly that is similar to the example of FIG. 1 in that it provides a direct-drive from the driver body 23 to the hub shell 10, but differs from the example in FIG. 1 in that the driver body 23 is substantially conically shaped as in the example of FIG. 2. Such direct-drive hub assembly and such exchangeable drive assembly that includes a conical driver body may be referred to herein as an third hub assembly and exchangeable third drive assembly respectively.

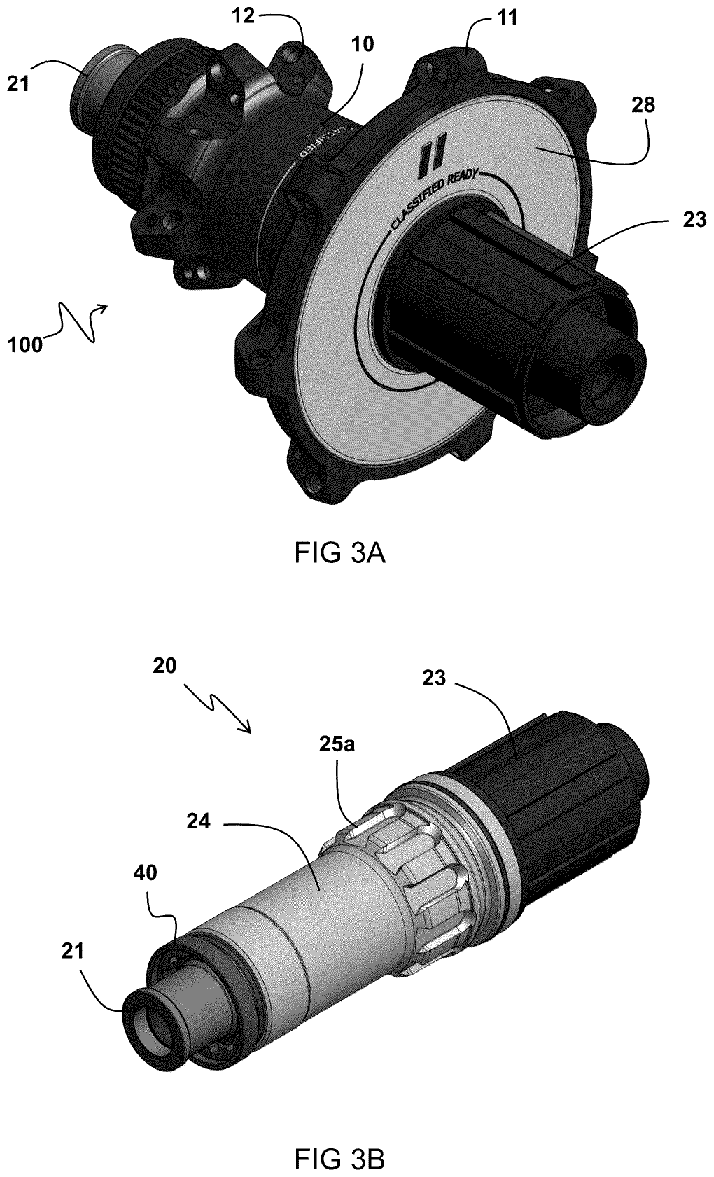

FIGS. 3A and 3B show perspective views of the first hub assembly 100 and the drive assembly 20 for the first hub assembly 100 respectively.

It will accordingly be appreciated that the hub shell 10 of the hub assemblies described herein may be the same or identical, and that the first, second and third exchangeable drive assemblies 20 can be used in combination with the same or identical hub shell 10. Hence, a flexible system is obtained in which a user can selectively couple any one of the drive assemblies 20 to the hub shell 10, e.g. depending on the type of cassette and the preference of an internal hub transmission.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A hub assembly for a driven wheel of a bicycle, comprising a hub shell for connection to a rim of the driven wheel, and an exchangeable drive assembly for being exchangeably couplable to the hub shell;
the exchangeable drive assembly comprising:
an axle;
a substantially cylindrical and/or conical driver body rotatable about the axle and configured for carrying a cassette of sprockets;
an inner hub body rotatable axially adjacent the driver body about the axle and comprising a splined first coupling interface configured for providing a direct-drive coupling between the inner hub body and the hub shell and a second coupling interface configured for providing a direct-drive coupling between the inner hub body and the driver body.

2. The hub assembly according to claim 1, comprising a freewheel mechanism operative between the driver body and the second coupling interface of the inner hub body for transferring torque from the driver body to the inner hub in one rotational direction about the axle and allow freewheeling of the driver body relative to the inner hub body in an opposite rotational direction about the axle.

3. The hub assembly according to claim 1, wherein the exchangeable drive assembly is a direct drive assembly configured for providing a fixed transmission path between the driver body and the hub shell, wherein the fixed transmission path can have a unitary transmission ratio.

4. The hub assembly according to claim 1, wherein the driver body is bearing mounted to the axle.

5. The hub assembly of claim 1, wherein the inner hub body is bearing mounted to the axle.

6. The hub assembly according to claim 1, wherein the freewheel mechanism comprises ratchet teeth protruding in axial direction with respect to the axle.

7. The hub assembly according to claim 1, wherein the freewheel mechanism comprises ratchet teeth protruding in radial direction with respect to the axle.

8. The hub assembly according to claim 1, wherein the freewheel mechanism comprises ratcheting pawls positioned on a larger diameter than the first coupling interface.

9. The hub assembly according to claim 1, comprising a sealing interface configured for providing a sealing engagement between the driver body and the inner hub body.

10. The hub assembly according to claim 1, wherein the inner hub body at the splined first interface includes axial splines arranged for enabling exchange of the drive assembly in axial direction with respect to the axle.

11. The hub assembly according to claim 10, wherein the drive body includes axial splines for supporting torque from the cassette of sprockets about the axle, and wherein the axial splines of the driver body and the axial splines of the inner hub body protrude in radial direction to a substantially corresponding radius.

12. The hub assembly according to claim 1, wherein the inner hub body at the splined first interface includes an axial abutment face for abutting a complementary abutment face associated with the hub shell.

13. The hub assembly according to claim 1, comprising a lock ring arranged for locking the inner hub body to the hub shell in axial direction with respect to the axle.

14. The hub assembly according to claim 13, wherein inner hub body and the lock ring include complementary inner and outer threads respectively.

15. The hub assembly according to claim 1, wherein the inner hub body is substantially cylindrical.

16. The hub assembly according to claim 1, comprising an annular shielding element that radially extends between the inner hub body and the hub shell in for shielding a gap between the inner hub body and the hub shell.

17. (canceled)

18. (canceled)

19. The hub assembly according to claim 1, wherein the axle is monolithic.

20. (canceled)

21. The hub assembly according to claim 1, wherein the inner hub body directly radially supports the hub shell.

22. (canceled)

23. A kit comprising a hub shell for connection to a driven wheel of a bicycle, an exchangeable first drive assembly and an exchangeable second drive assembly each for being exchangeably couplable to the hub shell,
the exchangeable first drive assembly comprising:
a first axle;
a substantially cylindrical driver body rotatable about the axle and configured for carrying a cassette of sprockets of a first type;
a first inner hub body rotatable axially adjacent the driver body about the first axle and comprising a splined first coupling interface configured for providing a direct-drive coupling between the inner hub body and the hub shell, and a second coupling interface configured for providing a direct-drive coupling between the inner hub body and the driver body;
the second drive assembly comprising:
a second axle;
a substantially conical driver body rotatably about the axle and configured for carrying a cassette of sprockets of a second type;
an second inner hub body rotatable axially adjacent the driver body about the axle and comprising the splined first coupling interface configured for providing the direct-drive coupling between the inner hub body and the hub shell;
a switchable transmission operative between the driver body and the inner hub body.

24. The kit according to claim 23, wherein the substantially conical driver body includes a coupling profile for coupling the cassette of sprockets thereto, wherein the coupling profile includes
a first support structure at a first radius from a centerline of the axle, configured for supporting the set of sprockets in a radial direction and/or an axial direction and/or tangential direction, and
a second support structure at a second radius from the centerline larger than the first radius, configured for supporting the set of sprockets in a tangential direction.

25.-27. (canceled)
